(19) United States
(12) Patent Application Publication
(10) Pub. No.: US 2026/0036676 A1
(43) Pub. Date: Feb. 5, 2026

(54) RADAR CONTROL DEVICE AND METHOD

(71) Applicant: HL KLEMOVE CORPORATION, Incheon (KR)

(72) Inventor: Sangmin PARK, Incheon (KR)

(21) Appl. No.: 18/974,258

(22) Filed: Dec. 9, 2024

(30) Foreign Application Priority Data
Jul. 30, 2024 (KR) 10-2024-0100954

(51) Int. Cl. G01S 7/40; G01S 13/931

(52) U.S. Cl. CPC G01S 7/4039; G01S 13/931

(57) ABSTRACT

The present embodiments relate to a radar control device and method. Specifically, a radar control device may include a radar sensor for receiving a reception signal which is a reflection signal of a radar signal radiated around a host vehicle through a plurality of channels, and a controller configured to perform Fast Fourier Transform (FFT) on the reception signal and determine whether at least a portion of the radar sensor is blocked based on a signal intensity detected from each of the plurality of channels.

### CROSS REFERENCE TO RELATED APPLICATION

This application claims priority from Korean Patent Application No. 10-2024-0100954, filed on Jul. 30, 2024, which is hereby incorporated by reference for all purposes as if fully set forth herein.

### BACKGROUND

### Technical Field

An embodiment of the present disclosure relates to a radar control device and a radar control method.

### Description of Related Art

Recently, the number of vehicles equipped with a radar sensor is increasing. An electronic control unit of a vehicle may calculate a distance, a relative speed, and an angle between the vehicle and an object around the vehicle based on the information output from the radar sensor mounted on the vehicle

In this way, a vehicle equipped with a radar sensor may provide various safety or convenience functions by using the distance, relative speed, and angle between the vehicle and objects around the vehicle.

For example, there may be performed a collision avoidance function while parked, a smart cruise function while driving, or an automatic parking function by using information input from the radar mounted on the vehicle to determine the distance, angle, or relative speed between the vehicle and objects around the vehicle.

Meanwhile, if the radar sensor for detecting the external environment is blocked by foreign substances (i.e., a blockage state), the radar sensor may not operate normally. In addition, even if the radar sensor is partially blocked (i.e., a partial blockage state), there may be detected an object. However, if the radar sensor is partially blocked, the detection performance may be lowered than normal, so that the detection may not be normally performed or an object may be detected to be present in different locations.

Since the performance degradation of the radar sensor may affect the provision of the safety or convenience functions of the vehicle, there is required a method for detecting the blockage or the partial blockage of the radar sensor.

### BRIEF SUMMARY

Embodiments of the present disclosure are to provide a radar control device and method capable of comparing the signal strength of each channel with a reference value to determine the blockage of an area of the radar sensor corresponding channel.

In accordance with an aspect of the present disclosure, there may be provided a radar control device including a radar sensor for receiving a reception signal through a plurality of channels, the reception signal being a reflected signal of a radar signal radiated around a host vehicle, and a controller configured to perform Fast Fourier Transform (FFT) on the reception signal and determine whether at least a portion of the radar sensor is blocked based on a signal intensity detected from each of the plurality of channels.

In accordance with another aspect of the present disclosure, there may be provided a radar control method including receiving, by a radar sensor, a reception signal through a plurality of channels, the reception signal being a reflected signal of a radar signal radiated around a host vehicle, performing an Fast Fourier Transform (FFT) on the reception signal to detect a signal intensity in each of the plurality of channels, and determining whether at least a portion of the radar sensor is blocked based on the signal intensity.

In accordance with another aspect of the present disclosure, there may be provided a non-transitory computer-readable recording medium recording a program for executing a radar control method, wherein the radar control method including performing an Fast Fourier Transform (FFT) on a reception signal through a plurality of channels of a radar sensor, the reception signal being a reflected signal of a radar signal radiated around a host vehicle, and detecting a signal intensity in each of the plurality of channels, and determining whether at least a portion of the radar sensor is blocked based on the signal intensity.

According to the present embodiments, it is possible to refine the blockage status or the occlusion status of the radar sensor during driving, thereby reducing false alarms regarding the blockage status.

In addition, according to the present embodiments, it is possible to determine a partial blockage of the radar sensor, thereby setting other functional errors in the radar sensor.

In addition, according to the present embodiments, it is possible to utilize the same logic even if a new radar sensor is used in the future, thereby facilitating expandability to other systems.

In addition, according to the present embodiments, it is possible to robustly estimate the state of the radar sensor and the surrounding environment since the value of white noise is smaller than the detected surrounding signal.

### BRIEF DESCRIPTION OF THE SEVERAL VIEWS OF THE DRAWINGS

FIG. 1 illustrates a radar control device according to an embodiment of the present disclosure.

FIG. 2 is a diagram for explaining the signal intensity of a radar sensor in a normal state according to an embodiment.

FIG. 3 is a diagram for explaining the signal intensity of each channel of a radar sensor in a partial blockage state according to an embodiment.

FIGS. 4A to 4D illustrate a radar sensor in a blockage state according to an embodiment.

FIGS. 5A to 5D illustrate a radar sensor in a blockage state according to another embodiment.

FIG. 6 illustrates a radar control device according to another embodiment.

FIG. 7 is a flowchart for explaining a radar control method according to an embodiment of the present disclosure.

FIG. 8 is a diagram for explaining step S730 according to an embodiment in more detail.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompass all the meanings of the term “can”.

Hereinafter, it will be described a radar control device according to one embodiment of the present disclosure with reference to the attached drawings.

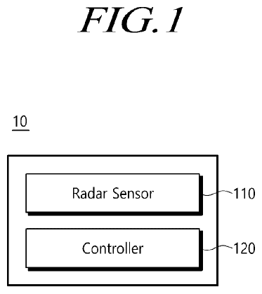

FIG. 1 illustrates a radar control device 10 according to an embodiment of the present disclosure.

Referring to FIG. 1, a radar control device 10 according to the present disclosure may include a radar sensor 110 and a controller 120.

In one embodiment, a radar control device 10 according to present disclosure may be a part of an advanced driver assistance system (ADAS) capable of providing information to assist driving of a vehicle or assists a driver in controlling the vehicle.

Here, ADAS may refer to various types of advanced driver assistance systems, and advanced driver assistance systems may include, for example, an Autonomous Emergency Braking (AEB) System, a Smart Parking Assistance System (SPAS), a Blind Spot Detection (BSD) system, an Adaptive Cruise Control (ACC) system, a Lane Departure Warning System (LDWS), a Lane Keeping Assist System (LKAS), a Lane Change Assist System (LCAS), and so on. However, the present disclosure is not limited thereto.

The radar control device 10 according to present disclosure may be installed in a manned vehicle in which a driver rides and controls the vehicle or an autonomous vehicle.

The radar control device 10 may receive a reception signal which is a reflected and returned signal of a radar signal radiated to the surroundings of a host vehicle and received through a plurality of channels, and may perform an FFT (Fast Fourier Transform) on the reception signal to determine whether at least a portion of the radar sensor 110 is blocked based on the signal intensity or the signal strength detected in each of the plurality of channels.

The radar sensor 110 may receive a reception signal which is reflected and returned signal of a radar signal radiated around the host vehicle and received by a plurality of channels. Each of the plurality of channels may include at least one transmitting antenna and at least one receiving antenna.

In one embodiment, the radar sensor 110 may include an antenna unit, a radar transmitter, a radar receiver, and the like.

Specifically, the antenna unit may include one or more transmitting antennas and one or more receiving antennas, and each transmitting/receiving antenna may be an array antenna in which one or more radiating elements are connected in series by a feed line, but is not limited thereto.

The antenna unit may include a plurality of transmitting antennas and a plurality of receiving antennas, and may have various types of antenna array structures depending on the arrangement order and arrangement interval, etc.

The radar transmitter may perform a function of switching to one of the plurality of transmitting antennas included in the antenna unit and transmitting a transmission signal through the switched transmitting antenna or transmitting a transmission signal through a multi-transmission channel assigned to the plurality of transmitting antennas.

The radar transmitter may include an oscillator for generating a transmission signal for one transmitting channel assigned to the switched transmitting antenna or a multi-transmission channel assigned to the plurality of transmitting antennas. The oscillator may include, for example, a voltage-controlled oscillator (VCO) and an oscillator.

The radar receiver may receive a reception signal reflected from an object and received through a receiving antenna.

In addition, the radar receiver may have a function of switching to one of a plurality of receiving antennas and receiving a reception signal which is a reflection signal of transmission signal reflected by a target and received through the switched receiving antenna, or receiving a reception signal through multiple receiving channels assigned to the plurality of receiving antennas.

The radar receiver may include a low noise amplifier (LNA) which low-noise-amplifies a reception signal received through one receiving channel assigned to the switched receiving antenna or through the receiving channels assigned to the plurality of transmitting antennas, a mixer which mixes the low noise-amplified reception signal, an amplifier which amplifies the mixed reception signal, and a converter (an analog-digital-converter; ADC) which digitally converts the amplified reception signal.

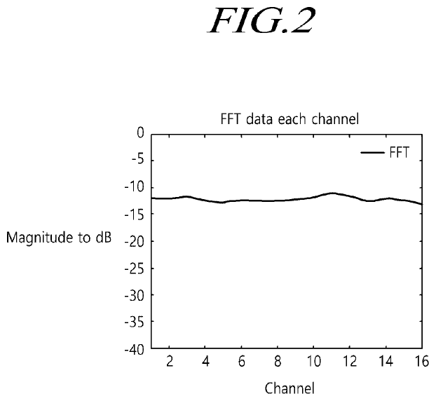

FIG. 2 is a diagram for explaining the signal intensity of a radar sensor 110 in a normal state according to an embodiment.

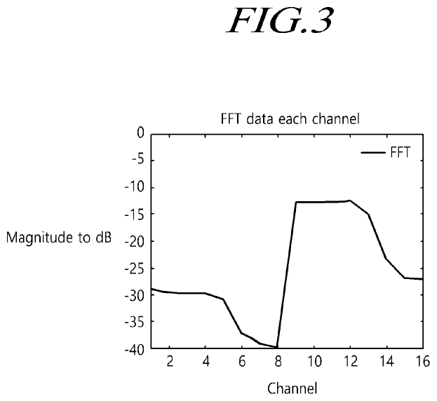

FIG. 3 is a diagram for explaining the signal intensity of each channel of a radar sensor 110 in a partial blockage state according to an embodiment.

The controller may determine whether at least a portion of the radar sensor 110 is blocked based on the signal intensity or the signal strength detected in each of the plurality of channels by performing FFT (Fast Fourier Transform) on the reception signal.

Specifically, the controller 120 may generate a beat signal by combining the reception signal and the transmission signal, and perform FFT on the beat signal to convert the beat signal into a frequency domain.

Referring to FIG. 2, there is illustrated the signal intensity in the case that the radar sensor 110 of the present disclosure is not blocked, in which the FFT data maintains a constant value in each channel. The signal intensity received in a normal state may be received higher than the strength of a white signal.

Referring to FIG. 3, in the case that the radar sensor 110 of the present disclosure is partially blocked, the FFT data may decrease in a specific channel.

Accordingly, the controller 120 may determine that the radar sensor 110 is blocked or covered if the difference between the intensity (dB) of the peaks detected in multiple channels and the reference value is greater than a predetermined value. The controller 120 may convert the signal intensity value (e.g., Magnitude) corresponding to the peak into a decibel value and compare the intensity between the signals.

Here, the reference value may be set as an average value of the signal intensity detected in each channel.

In one embodiment, the controller 120 may determine whether the radar sensor 110 is partially blocked by comparing the number of peaks detected in each channel with a predetermined number. For example, the controller 120 may compare the total number of peaks detected in each channel with the number of peaks when an object is detected in a normal state, and determine whether the radar sensor 110 is partially blocked by the difference in the number. If a partial blockage occurs in the radar sensor 110, the total number of peaks may be detected as low.

The controller 120 may divide the front of the radar sensor 110 into a plurality of areas including at least one channel. In addition, if it is determined that a channel included in each area is blocked, the controller may determine that the area including the channel is blocked. In one embodiment, the front may mean a part where an antenna is disposed to transmit and receive signals through the antenna.

The controller 120 may determine that the radar sensor 110 is partially blocked if at least one area is blocked or covered.

According to the present disclosure, it is possible to reduce false alarms regarding the blockage state by segmenting the blockage state of the radar sensor 110 during driving of a host vehicle.

In addition, the controller 120 may determine that the radar sensor 110 is covered if more than half of the areas are blocked.

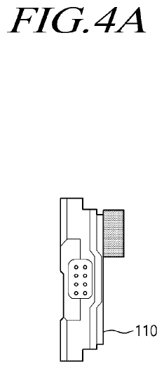

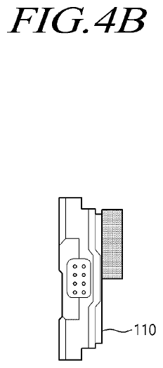

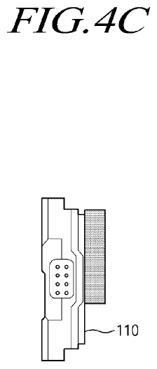

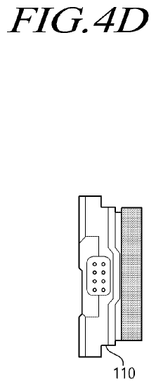

FIGS. 4A to 4D illustrate a radar sensor 110 in a blockage state according to an embodiment.

Referring to FIGS. 4A to 4D, the controller 120 may determine the blockage information or the occlusion information of the radar sensor 110 based on the signal intensity of the channel, and may classify the blockage area of the radar sensor 110 into upper and lower parts according to the antenna arrangement. For example, the controller 120 may classify the front part of the radar sensor 110 into an upper 30% blockage as in FIG. 4A, an upper 50% blockage as in FIG. 4B, an upper 70% blockage as in FIG. 4C, and an upper 100% blockage as in FIG. 4D.

The controller 120 may determine the partial blockage or the full blockage according to the blockage area. For example, the controller 120 may determine that the upper 30% blockage or a lower 30% of blockage the front surface is the partial blockage, and the upper 50% blockage or the upper 70% blockage is the full blockage or an entire blockage.

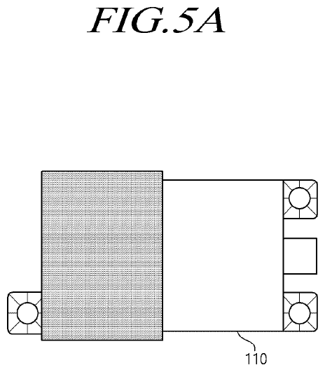

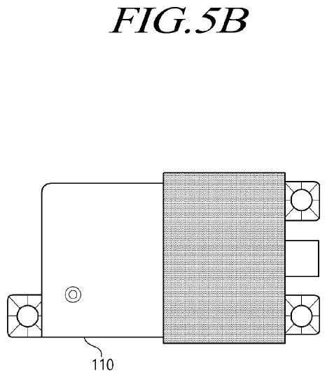

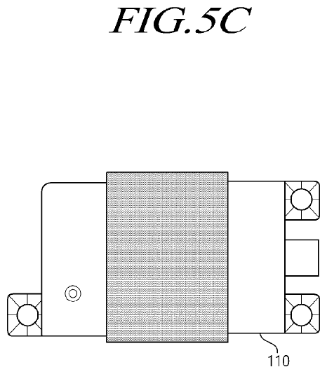

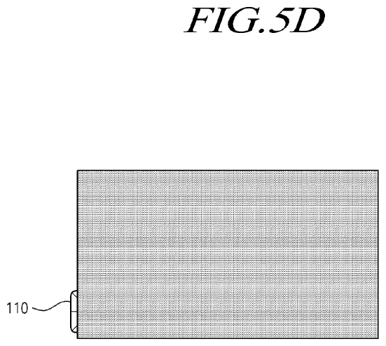

FIGS. 5A to 5D illustrate a radar sensor 110 in a blockage state according to another embodiment.

Referring to FIGS. 5A to 5D, the controller 120 may divide a plurality of areas into one of a left area, a middle area, and a right area, and determine the blockage position of the radar sensor 110 based on the blocked area. If the controller 120 may determine that the radar sensor 110 is partially blocked if one area among the left area, the middle area, and the right area is blocked. As shown in FIG. 5D, the controller 120 may determine that the radar sensor 110 is entirely blocked, that is, is in a full blockage state if at least two areas among the left area, the middle area, and the right area are blocked.

According to the present disclosure, it is possible to provide additional data for detailed error setting of other functions within the radar sensor 110 by determining partial blockage of the radar sensor 110.

The radar control device 10 of the present disclosure may further include an output unit for outputting an alarm for limiting an ADAS function based on the blockage area.

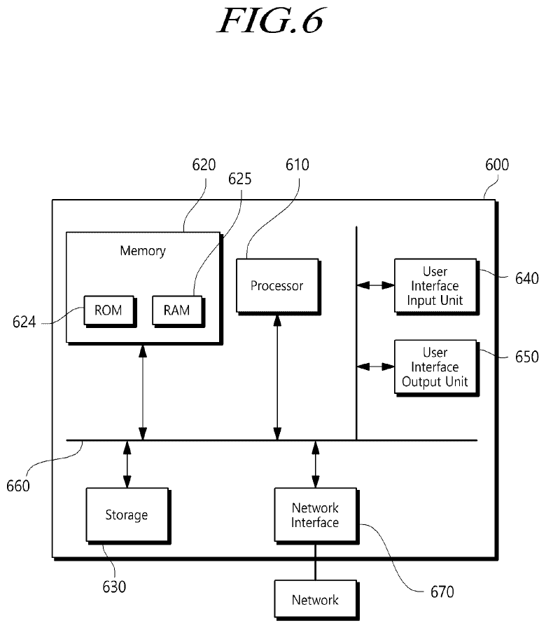

FIG. 6 illustrates a radar control device 10 according to another embodiment.

In one embodiment, the radar control device 10 may be implemented as an electronic control unit (ECU), or a microcomputer.

Referring to FIG. 6, the above-described present embodiments may be implemented in a computer system, for example, as a computer-readable recording medium. As illustrated, a computer system 1000 of the radar control device 10 may include one or more elements of one or more processors 610, a memory 620, a storage 630, a user interface input unit 640, and a user interface output unit 650, and the elements may communicate with each other through a bus 660. In addition, the computer system 1000 may also include a network interface 670 for connecting to a network. The processor 610 may be a central processor (CPU) or a semiconductor device that executes processing instructions stored in the memory 620 and/or the storage 630. The memory 620 and the storage 630 may include various types of volatile/nonvolatile storage media. For example, the memory may include a read-only memory (ROM) 624 and a random access memory (RAM) 625.

Hereinafter, it will be described a radar control method using a radar control device 10 capable of performing all of the present disclosures.

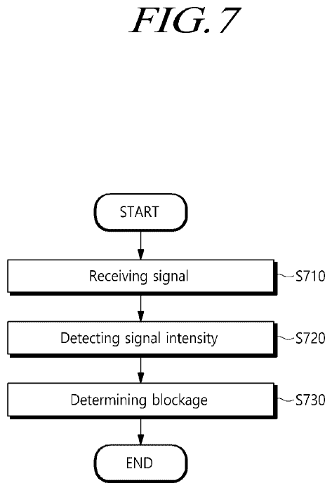

FIG. 7 is a flowchart for explaining a radar control method according to an embodiment of the present disclosure.

Referring to FIG. 7, a radar control method according to an embodiment of the present disclosure may include a receiving step (S710) of receiving a reception signal through a plurality of channels. In this case, the reception signal may be a reflected and returned signal of a radar signal radiated to the surroundings of a vehicle. The radar control method according to an embodiment of the present disclosure may include a signal intensity detection step (S720) of performing an FFT (Fast Fourier Transform) on the reception signal to detect signal intensity in each of the plurality of channels, and a control step (S730) of determining whether at least a portion of a radar sensor 110 is blocked based on the signal intensity. Here, each of the plurality of channels may include at least one transmitting antenna and one receiving antenna.

The receiving step (S710) may include receiving pre-processing information when the vehicle is in a radiation on state. Here, the radiation on state may mean a state in which the radar sensor 110 is activated and transmitting a signal. The pre-processing information may be information converted into meaningful information by processing collected raw data in an initial stage. The pre-processing information may be the result of operations such as noise removal, filtering, signal amplification, and conversion.

The signal intensity detection step (S720) may include acquiring FFT data of each channel and calculating the signal intensity value of each peak using the channel FFT data. Thereafter, the signal intensity may be converted into a decibel value.

The control step (S730) may include determining that the radar sensor 110 is blocked if the difference between the intensity (dB) of peaks detected in the plurality of channels and a reference value is greater than a predetermined value or a predetermined level. Here, the reference value may be set to the average value of the signal intensities detected in each channel.

The control step (S730) may include determining the partial blockage of the radar sensor 110 by comparing the number of peaks detected in each channel with a predetermined number. Here, the predetermined number may be set to the number of peaks when an object within the detection range is detected by a radar sensor 110 in a normal state.

The control step (S730) may include dividing the front of the radar sensor 110 into a plurality of areas each including at least one channel. In addition, if it is determined that a channel included in each area is blocked, there may be determined that the area including the channel is blocked.

According to the present disclosure, there may further classify the blockage state of the radar sensor 110 during driving of the host vehicle, thereby reducing false alarms regarding the blockage state.

The control step (S730) may include determining that the radar sensor 110 is blocked if more than half of the areas are blocked.

The control step (S730) may include dividing the plurality of areas into one of the left area, the middle area, and the right area, and determining the blockage position of the radar sensor 110 based on the blocked area. The above-mentioned areas may be set so that each area evenly includes a plurality of channels therein.

If it is determined that at least two areas among the left area, the middle area, and the right area are blocked in the control step (S730), there may be determined that the entire radar sensor 110 is blocked.

Accordingly, it is possible to help to set other function errors in the radar sensor 110 by determining the blocked area of the radar sensor 110.

The radar control method of the present disclosure may further include an output step of outputting an alarm for limiting an ADAS function based on the blocked area.

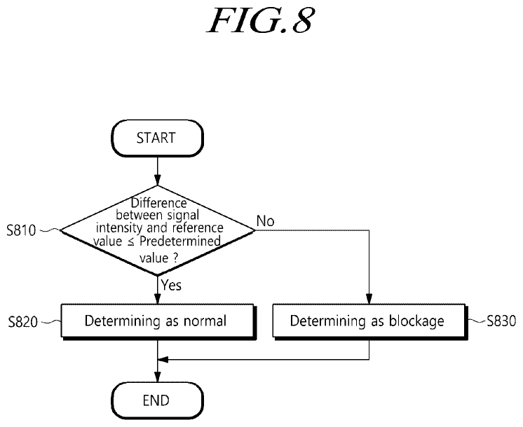

FIG. 8 is a diagram for explaining step S730 according to an embodiment in more detail.

Referring to FIG. 8, the radar control device 10 may determine whether the difference between the signal intensity of the channel and the reference value is less than or equal to a predetermined value (S810). If the signal intensity is maintained for a predetermined time, the radar control device 10 may determine whether the difference between the signal intensity of the corresponding channel and the reference value is less than or equal to a predetermined value or a predetermined level.

If the difference between the signal intensity of the channel and the reference value is less than or equal to a predetermined value (Yes in S810), the radar control device 10 may determine that the radar sensor 110 is in a normal state (S820).

If the difference between the signal intensity of the channel and the reference value exceeds a predetermined value (No in S810), the radar control device 10 may determine that the radar sensor 110 is in a blockage state (S830). The radar control device 10 may determine the blockage state or a normal state of a specific position of the radar sensor 110 depending on the position of the channel.

In addition, a program for executing the radar control method described with reference to FIGS. 7 and 8 may be recorded on a non-transitory computer-readable recording medium. In the following, a part of the description may be omitted to avoid redundant description, but it will be understood that all embodiments according to the aforementioned radar control method may be applied to the recording medium.

According to one embodiment, in a non-transitory computer-readable recording medium, there may be recorded a program for executing a radar control method including a signal intensity detection step of performing an FFT (Fast Fourier Transform) on a reception signal received through a plurality of channels of a radar sensor, which the reception signal is a reflected signal of a radar signal radiated to the surroundings of a host vehicle, and detecting a signal intensity in each of the plurality of channels, and a control step of determining whether at least a portion of the radar sensor is blocked based on the signal intensity. As described above, according to the present disclosure, the radar control device and method may further subdivide the blocking state of the radar sensor during driving of the host vehicle, thereby reducing false alarms regarding the blocking state.

In addition, according to the present disclosure, it is possible to help to set other functional errors in the radar sensor by determining partial blockage of the radar sensor.

In addition, the radar control device and method according to the present disclosure may be easily applied to other systems since the same logic can be used even if a new radar sensor is used in the future.

In addition, according to the present disclosure, it is possible to robustly estimate the state of the radar sensor and the surrounding environment since the value of white noise is smaller than the detected surrounding signal.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

1. A radar control device comprising:
a radar sensor configured to receive a reception signal through a plurality of channels, the reception signal being a reflected signal of a radar signal radiated around a host vehicle; and
a controller configured to perform Fast Fourier Transform (FFT) on the reception signal and determine whether at least a portion of the radar sensor is blocked based on a signal intensity detected from each of the plurality of channels.

2. The radar control device of claim 1, wherein the controller determines that at least a portion of the radar sensor is blocked if a difference between an intensity (dB) of a peak detected in the plurality of channels and a reference value is greater than a predetermined value.

3. The radar control device of claim 2, wherein the reference value is set as an average value of signal intensities detected in each channel.

4. The radar control device of claim 1, wherein the controller compares the number of peaks detected in each channel with a predetermined number to determine a partial blockage of the radar sensor.

5. The radar control device of claim 1, wherein the controller divides a front surface of the radar sensor into a plurality of areas each including at least one channel,
wherein, if it is determined that a channel included in each area is blocked, the controller determines that an area including the channel is blocked.

6. The radar control device of claim 5, wherein the controller determines that the radar sensor is blocked if more than half of the plurality of areas are blocked.

7. The radar control device of claim 5, wherein the controller divides the plurality of areas into one of a left area, a middle area, and a right area, and determines a blockage position of the radar sensor based on a blocked area.

8. The radar control device of claim 7, wherein, if the controller determines that at least two areas among the left area, the middle area, and the right area are blocked, the controller determines that the entire radar sensor is blocked.

9. The radar control device of claim 1, further comprising an output unit for outputting an alarm to limit an advanced driver assistance system (ADAS) function based on a blocked area.

10. The radar control device of claim 1, wherein each of the plurality of channels includes at least one transmitting antenna and at least one receiving antenna.

11. A radar control method comprising:
receiving, by a radar sensor, a reception signal through a plurality of channels, the reception signal being a reflected signal of a radar signal radiated around a host vehicle;
performing a Fast Fourier Transform (FFT) on the reception signal to detect a signal intensity in each of the plurality of channels; and
determining whether at least a portion of the radar sensor is blocked based on the signal intensity.

12. The radar control method of claim 11, wherein the determining includes determining that at least a portion of the radar sensor is blocked if a difference between an intensity (dB) of a peak detected in the plurality of channels and a reference value is greater than a predetermined value.

13. The radar control method of claim 12, wherein the reference value is set as an average value of signal intensities detected in each channel.

14. The radar control method of claim 11, wherein the determining includes comparing the number of peaks detected in each channel with a predetermined number to determine a partial blockage of the radar sensor.

15. The radar control method of claim 11, wherein the determining includes dividing a front surface of the radar sensor into a plurality of areas each including at least one channel,
wherein, if it is determined that a channel included in each area is blocked, the determining includes determining that an area including the channel is blocked.

16. The radar control method of claim 15, wherein the determining includes determining that the radar sensor is blocked if more than half of the plurality of areas are blocked.

17. The radar control method of claim 15, wherein the determining includes dividing the plurality of areas into one of a left area, a middle area, and a right area, and determining a blockage position of the radar sensor based on a blocked area.

18. The radar control method of claim 17, wherein the determining includes determining that the entire radar sensor is blocked if it is determined that at least two areas among the left area, the middle area, and the right area are blocked.

19. The radar control method of claim 11, further comprising outputting an alarm to limit an advanced driver assistance system (ADAS) function based on a blocked area.

20. A non-transitory computer-readable recording medium recording a program for executing a radar control method, wherein the radar control method comprising:
performing a Fast Fourier Transform (FFT) on a reception signal through a plurality of channels of a radar sensor, the reception signal being a reflected signal of a radar signal radiated around a host vehicle, and detecting a signal intensity in each of the plurality of channels; and
determining whether at least a portion of the radar sensor is blocked based on the signal intensity.
